(19) United States
(12) Patent Application Publication
(10) Pub. No.: US 2002/0188819 A1
(43) Pub. Date: Dec. 12, 2002

(54) Data processing device

(76) Inventors: Alexander Benedix, Munchen (DE); Sebastian Kuhne, Radebeul (DE); Bernd Klehn, Unterhaching (DE)

Correspondence Address: LERNER AND GREENBERG, P.A., Post Office Box 2480, Hollywood, FL, 33022-2480, US

(21) Appl. No.: 10/167,786

(22) Filed: Jun. 12, 2002

(30) Foreign Application Priority Data
Jun. 12, 2001 (DE) 101 28 373.3

(51) Int. Cl. G06F 12/00

(52) U.S. Cl. 711/206

(57) ABSTRACT

The data processing device has a processor with a cache memory, a system memory that can be connected to the processor, and a translation unit that can convert an external instruction or a group of external instructions into internal instructions by a translation process. The translation unit is formed by a computing unit assigned to the system memory, for carrying out the translation processes using the system memory.

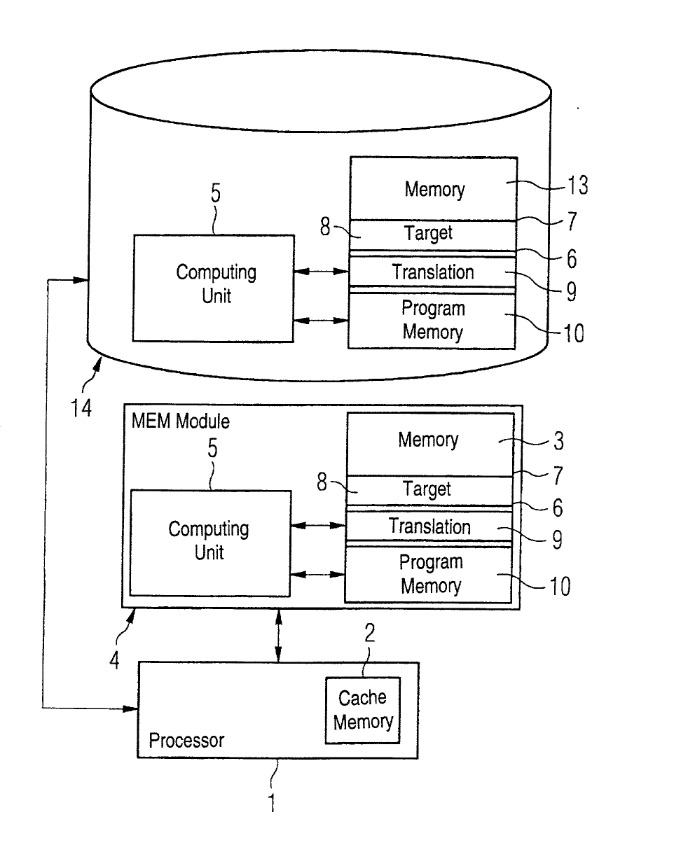

### BACKGROUND OF THE INVENTION

### Field of the Invention

The invention relates to a data processing device having a processor having a cache memory, a system memory, which can be connected to the processor, and a translation unit, which can convert an external instruction or a group of external instructions into internal instructions by a translation process.

Such data processing devices are used in computing systems using so-called hardware-software hybrid technology. In systems of this type, there is an external instruction set and an internal instruction set which differs therefrom. The internal instruction set can be optimized with respect to the specific hardware structure of the processor without giving rise to compatibility difficulties with the external instruction set, which is originally provided for other processor types.

Data processing devices of this type are known for example from the processors of the company Transmeta. A description of Tansmeta's CRUSOE processors in the online article “The Technology behind CRUSOE Processors”, http://www.transmeta.com/crusoe/download/pdf/crusoetechwp.pdf, January 2000, discloses a hardware-software hybrid system wherein the translation unit is formed by a specific software running on the main processor. Such often dynamic software translation operations retard the processing of the actual processing processes running on the processor.

### SUMMARY OF THE INVENTION

It is accordingly an object of the invention to provide a data processing device, which overcomes the above-mentioned disadvantages of the heretofore-known devices and methods of this general type and wherein translation processes are carried out in such a way that the burden for the processor is reduced.

With the foregoing and other objects in view there is provided, in accordance with the invention, a data processing device, comprising:

a processor having a cache memory;

a system memory connectible to the processor, and a translation unit configured to convert an external instruction or a group of external instructions into internal instructions with a translation process; and the translation unit comprising a computing unit assigned to the system memory and configured to carry out translation processes using the system memory.

In other words, the objects of the invention are achieved with a data processing device of the type mentioned in the introduction which is characterized with a translation unit formed by a computing unit assigned to the system memory, for carrying out the translation processes using the system memory.

The advantage of such a device is that the processor for carrying out the “actual work” is not burdened by the translation process, rather the latter can be swapped out to a separate computing unit. This computing unit is assigned to the system memory, so that the often memory-intensive translation process can be processed in an optimized manner and the cache memory of the processor does not have to be used.

In accordance with an added feature of the invention, the instructions to be translated are defined with start and end addresses and translated instructions are defined with a destination address, and wherein the computing unit receives from the processor the start and end addresses and the destination address.

In accordance with an additional feature of the invention, the system memory includes a local program memory assigned to the computing unit.

In accordance with another feature of the invention, the system memory is a RAM and the computing unit is commonly integrated with the RAM system memory on a semiconductor chip. In this particularly suitable embodiment, the computing unit forms, with a RAM system memory, a separate module wherein the system memory and the computing unit are integrated on a single semiconductor chip. In this case, the system memory can also be used like a customary DRAM.

In a particularly advantageous mode of interaction, the processor transfers to the computing unit the start and end addresses of the instructions to be translated and also destination addresses of the translated instructions, so that, after the end of the translation process, the processor can load the translated instructions directly from the system memory into its cache memory.

In accordance with concomitant feature of the invention, the computing unit has a more restricted and/or different instruction set than the processor. In this favorable embodiment, the computing unit is provided with a special instruction set which is optimized for carrying out translation processes.

Other features which are considered as characteristic for the invention are set forth in the appended claims.

Although the invention is illustrated and described herein as embodied in a data processing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The FIGURE shows an exemplary embodiment of a data processing device according to the invention.

### DESCRIPTION OF THE PREFERRED EMBODIMENTS

Referring now to the sole FIGURE of the drawing in detail, there is shown a data processing device with a processor 1 having a cache memory 2 into which the program parts provided for execution are respectively loaded. A memory module 4 is connected to the processor 1. The memory module has a RAM (Random Access Memory), one area being embodied as system memory 3. Furthermore, the memory module 4 has a computing unit 5 which interacts with the memory.

In addition to the memory module 4, the data processing device illustrated has a hard disk unit 14. Part of the memory thereof is embodied as hard disk system memory 13, but other areas can be embodied using DRAM technology. The hard disk unit 14 also has a computing unit 5.

During operation of a data processing device according to the invention, the processor 1 recognizes that instructions of an external instruction set are to be processed, which instructions must be translated prior thereto. It stores the instructions to be translated in a target memory area 8 and informs the computing unit 5 of the start address 6 and end address 7 of this area. In addition, the computing unit 5 is informed of the memory area 9 wherein the translated instructions are to be stored. It is thereupon possible for the computing unit 5 to translate the desired instructions, wherein case a local program memory 10 can also be used during the calculation. The DRAM system memory area 3 can be utilized by the processor 1 as in a conventional main memory. An impairment of the performance of the processor 1 or of the interaction of the processor 1 with the system memory 3 or 13 does not take place.

After the end of the translation processes, the translated instructions can be retrieved from the memory area 9 by the processor 1 and executed in the processor 1.

In order to optimize the hardware-software hybrid technology, it is provided that not only are individual instructions inserted into the instruction set of the processor, rather an entire group of instructions from the external instruction set is converted into corresponding instructions of the processor 1. The possibilities of the processor 1 can thus be better utilized, for example if its instruction set is of hardware-optimized or power-saving design.

It should be understood that the invention is not only restricted to a computing unit with the associated memory as support in carrying out translation processes, rather it is also possible to use other computing units with corresponding memories. This is done by the hard disk unit 14 in the exemplary embodiment of the FIGURE. The construction and method of operation are identical to the memory module 4, apart from the fact that a hard disk system memory 13 is employed instead of a DRAM system memory 3.

We claim:

1. A data processing device, comprising:
a processor having a cache memory;
a system memory connectible to said processor, and a translation unit configured to convert an external instruction or a group of external instructions into internal instructions with a translation process; and
said translation unit comprising a computing unit assigned to said system memory and configured to carry out translation processes using said system memory.

2. The data processing device according to claim 1, wherein the instructions to be translated are defined with start and end addresses and translated instructions are defined with a destination address, and wherein said computing unit receives from said processor said start and end addresses and said destination address.

3. The data processing device according to claim 1, wherein said system memory includes a local program memory connected to said computing unit.

4. The data processing device according to claim 1, wherein said computing unit has a more restricted instruction set than said processor.

5. The data processing device according to claim 1, wherein said computing unit has a different instruction set than said processor.

6. The data processing device according to claim 1, wherein said system memory is a RAM and said computing unit is commonly integrated with said RAM system memory on a semiconductor chip.
